(19) United States
(12) Patent Application Publication
(10) Pub. No.: US 2014/0299308 A1
(43) Pub. Date: Oct. 9, 2014

(54) WINDSHIELD WASHER FLUID HEATING APPARATUS, CONTROL SYSTEM, AND METHOD OF USING SAME

(71) Applicant: Shayne Elliott, Mission (CA)

(72) Inventor: Shayne Elliott, Mission (CA)

(21) Appl. No.: 14/242,643

(22) Filed: Apr. 1, 2014

Related U.S. Application Data
(60) Provisional application No. 61/808,132, filed on Apr. 3, 2013.

(51) Int. Cl. B60S 1/48

(52) U.S. Cl. CPC B60S 1/487
USPC 165/292

(57) ABSTRACT

An apparatus for heating and controlling windshield washer fluid temperature is provided, comprising a washer fluid reservoir; a hollow conductive tube in the reservoir containing a heated working fluid for delivering heat to the washer fluid; a valve for controlling the flow rate of the working fluid through the tube; and a control system for controlling the temperature of the fluid in the reservoir. A method for controlling the heating of the washer fluid and for storing heated washer fluid is also disclosed. The apparatus may be installed at the time of manufacture of the vehicle or installed after market as a retro-fit kit. The windshield washer apparatus and control system permits vehicles to operate in cold environments for sustained periods of time at various speeds without thermal shock to the windshield during cleaning with washer fluid.

### 1. TECHNICAL FIELD

An embodiment of the present invention relates generally to windshield wiping systems and methods of use thereof. More particularly, an embodiment of the present invention relates to a windshield washer fluid heating apparatus, temperature control system for windshield wiper fluid heating a windshield washer fluid heating apparatus, and method of use thereof.

### 2. BACKGROUND

Warm fluids may improve speed and effectiveness of cleaning automotive windshields. Windshields are typically cleaned with washer fluid that is applied by spray. The effectiveness of cleaning a windshield is influenced by the type of fluid, the manner in which the fluid is applied, and the temperature of both the fluid and windshield. With warm washer fluid, dirt and other matter are removed more quickly and easily. In cold climates, use of warm washer fluid may pose a threat to the windshield by increasing the likelihood of thermal or thermo-kinetic shock cracking or breaking the windscreen. Also, even though washer fluid often comprises water and methyl alcohol (methanol), the methanol often evaporates once sprayed, leaving a solution of mostly water which then may undesirably freeze on the windscreen in cold environments.

Windshield washer fluid may be heated via electrical heating elements where application of electrical heat controls when the washer fluid is heated, however, such electrical elements may undesirably raise the risk of fire. Accordingly, there is a need for improved methods of applying heat to washer fluid.

In addition to electrically heated washer fluid systems, other fluid heating methods involve utilizing capturing the heat of the vehicle engine. Vehicle engine heat may be utilized for washer fluid heating by passing the washer fluid lines around or adjacent to a heater core heated by a vehicle engine coolant. However, in such methods relying on heating by a heater core may provide insufficient supply of heated washer fluids, where the heated fluid supply may be quickly exhausted in operation and the temperature of the washer fluid cannot be controlled, it is determined by the temperature of the heater core and the amount of heat transferred to the fluid at the time of demand.

Subsequently, there remains a need for techniques and apparatus to improve both the method of heating windshield washer fluid and to control the temperature of heated windshield washer fluid.

### 3. BRIEF SUMMARY

In an embodiment of the present invention, an apparatus for heating and controlling fluid temperature is provided comprising a windshield washer fluid reservoir, a heat tube disposed in the reservoir, a valve for controlling a flow rate of a working fluid through the tube, a control system for controlling a temperature of a fluid in the reservoir, the control system comprising a first sensor disposed within the reservoir for measuring a first temperature within the reservoir, a second sensor disposed outside of the reservoir for measuring a second temperature, and a controller for adjusting the valve based on a differential between the first and second temperatures and the predetermined temperature differentials, and a power source for delivering power to the control system.

A method for controlling the heating of the washer fluid and for storing heated washer fluid is also disclosed for heating and controlling windshield washer fluid temperature in a vehicle, the method comprising providing apparatus for heating and controlling fluid temperature, which comprises a windshield washer fluid reservoir, a heat tube disposed in the reservoir, a valve for controlling a flow rate of a working fluid through the tube, and a control system for controlling a temperature of a fluid in the reservoir, the control system comprising a first sensor disposed within the reservoir for measuring a first temperature within the reservoir, a second sensor disposed outside of the reservoir for measuring a second temperature, and a controller for adjusting the valve based on a differential between the first and second temperatures and the predetermined temperature differentials, and a power source for delivering power to the control system. The method also comprises providing a stored predetermined temperature differential, measuring a first temperature in the reservoir, measuring a second temperature outside of the reservoir, storing the first and second measured temperatures, calculating an actual temperature differential between the measured temperatures, comparing the actual temperature differential with the stored predetermined temperature differential, and adjusting the delivery of heat to the fluid in the reservoir by adjusting the position of the valve in response to a differential between the actual temperature differential with the stored predetermined temperature differential. The method adjusting the delivery of heat to the fluid in the reservoir may comprise closing the valve if the actual temperature differential is equal to or less than the stored temperature differential, or opening the valve if the actual temperature differential is greater than the stored temperature differential.

In an embodiment, the control system may be installed at the time of manufacture of the vehicle or installed after market as a retro-fit kit.

The windshield washer apparatus and control system may permit vehicles to operate in cold environments for sustained periods of time at various speeds by mitigating the risk of thermal shock to the windshield during cleaning with washer fluid, as the apparatus and system provides a sustained amount of washer fluid having a temperature sufficiently close to that of the ambient temperature.

### 4. BRIEF DESCRIPTION OF THE DRAWINGS

Embodiments of a windshield washer fluid temperature control apparatus, system, and method according to the present invention will now be described with reference to the accompanying drawing figure, in which:

FIG. 1 is a schematic diagram of an apparatus, system and method to control heating windshield washer fluid from engine heat in accordance with an embodiment of the present invention.

### 5. DETAILED DESCRIPTION

As described above, there remains a need for a windshield washer fluid heater which provides a reservoir of heated washer fluid and a system to control the temperature of the fluid in the reservoir in a manner sufficient to operate the system for sustained periods under certain environmental conditions, such as extreme cold or wind in order to prevent washer fluid from freezing on the windshield, preventing thermal shock, and accordingly, mitigating risk of damage to the windshield.

It is important in a cold environment to safely control the temperature of windshield washer fluid, also referred to as windshield wiper fluid, screen wash and washer fluid, and provide sufficient heated fluid for a vehicle operating in cold environments. An embodiment of the present invention is directed to an apparatus, system, and method which may be used in conjunction with vehicles and other machines with an engine and a windshield in order to control the washer fluid temperature and provide a sufficient reserve of heated fluid for all operating conditions, such as extremely cold environments where the vehicle may be traveling at a high rate of speed for lengthy periods of time.

Washer fluids comprising a substance having relatively low freezing points, such as methanol, may not prevent washer fluid from freezing on windscreens. Other environmental factors, such as the velocity of air moving along a windscreen surface, may increase the rate of evaporation of such a substance, in part or as a whole, from a windscreen surface. For example, as washer fluid comprising a mixture of water and at least another substance having a freezing point that less than the freezing point of water is sprayed onto a vehicle windscreen, and the substance with the relatively low freezing point evaporates relatively quickly and leaves the unevaporated fluid component on the surface with a relatively higher freezing point to freeze on the windscreen surface and possibly cause damage to the surface.

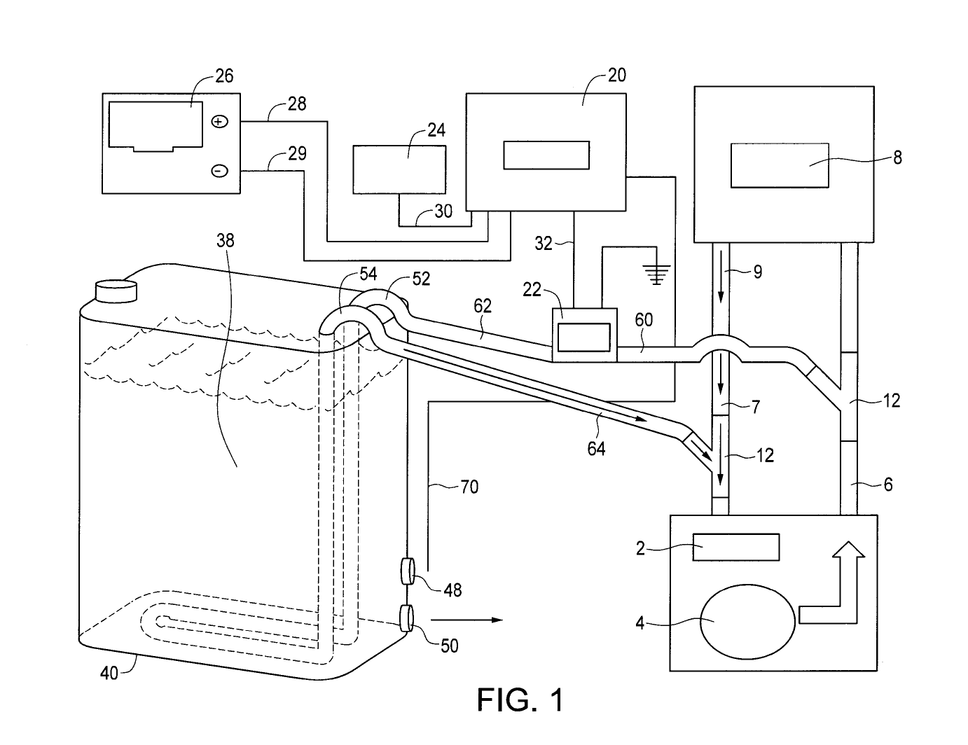

Referring to FIG. 1, in an embodiment of the invention, a system is installed in a vehicle having an engine 2, a heater core 8, a coolant pump 4, and an engine coolant outlet line 6 and an engine coolant inlet line 7 through which engine coolant circulates, primarily to cool the engine. In an embodiment, the coolant is heated by passing through the engine and then passes through the heater core 8 which, typically by means of a heat exchanger and fan, provides warm air for the passenger compartment of the vehicle, resulting in a heated working fluid 9 circulating between the engine and heater core. In an embodiment, passing fluid through or about a heater core 8 may be one way of obtaining a heated working fluid 9, but other methods of heating the fluid may be used.

An embodiment of the present invention also comprises a washer fluid reservoir 40, with a heating element 42 disposed there within, optimally comprising a tube, such as a heat conductive tube. The heating element 42 may comprise a tube of suitable dimension and material, such as a half inch diameter tube, comprising a heat conductive material, including but not limited to copper, rubber, synthetic compounds, or heat resistant materials. In an embodiment, the heating element 42 may have a large proportion of the tubing disposed at the lower portion of the reservoir 40, such that the heating of the fluid 38 in the reservoir 40 may be more efficiently heated at low fluid levels. In one aspect, the heating element 42 has an inlet 52 and outlet 54 which may be disposed at or above the top level of the reservoir 40. An engine coolant to control valve line 60 may be fluidly connected by way of a Y joint or other commercially available connection 12 to the engine coolant outlet line 6 at one end, and the other end may be fluidly connected to a control valve 22. In one embodiment, the control valve 22 may comprise an electric solenoid control valve in a normally-closed state, or alternatively a suitable fluid control valve, such as a gate, butterfly, or vacuum control valve. The control valve 22 may be controlled by a controller 20, which may be a programmable PLC, including but not limited to an STC1000® model with two contact relays and a programmable keypad. In an embodiment, the control valve 22 is in a closed position. The controller may also be attached to a temperature sensor 24, which is placed on the exterior of the vehicle and senses a temperature of the ambient, such as air temperature. Valve 22, controller 20 and sensor 24 may operate on a power source, such as the vehicle battery 26. In an embodiment the controller may also be an electric control switch.

In an embodiment, a control valve to reservoir line 62 connects the valve to the heating element inlet 52. Also in an embodiment, a coolant outlet line 64 connects the heating element outlet 54 to the coolant inlet line 7.

In an embodiment, the apparatus and system comprise a washer fluid temperature sensor in the reservoir 40 for determining the temperature of the washer fluid 38. Also in an embodiment, the apparatus and system may comprise a reservoir outlet 50 for connecting the washer reservoir 40 to the washer fluid spray apparatus (not shown) of any suitable type.

In operation, in an embodiment, ambient sensor 24 senses an ambient temperature, such as the air surrounding the apparatus and system. The ambient temperature is then transmitted to the controller 20, and compared to the temperature of the washer fluid 38 as determined and transmitted by the washer fluid temperature sensor and then transmitted to the controller 20. Using a pre-programmed algorithm, the controller 20 determines a desired temperature of the washer fluid 38, for example, 10 degrees Fahrenheit higher than the ambient temperature, although the algorithm may vary the temperature differential, for example when the ambient temperature is relatively low. In an embodiment, if the temperature of the fluid 38 is lower than the desired temperature, the controller 20 may instruct the valve 22, for example when it is in a closed position, to open and admit the heated working fluid 9 exiting the engine 2 through the control valve to reservoir line 62 and heating element inlet 52 and through the heating element 42, thereby increasing the temperature of the fluid 38. In an embodiment, the heating element 42 may be a tube, such as a copper tube, and disposed in a shape, such as a U-shape as depicted in FIG. 1, that maximizes the surface area of the element 42 exposed to the fluid 38 at the lowest point possible in order to encourage even heating of the fluid 38 in the reservoir 40 due to the heat rising through the reservoir 40 from the bottom and creating eddy currents which promote fluid mixing. In an embodiment, once a desired temperature is sensed by the fluid temperature sensor 48, and via temperature sensor input line 70, the controller 20 instructs the valve 22 to close. The controller 20 may, in alternate embodiments, selectively control the valve 22 by adjusting the valve 22 between partially or fully open or closed positions to accelerate or decelerate heated fluid flow through the heating element 42.

In an embodiment, when heated fluid 38 is sprayed on the windshield (not shown), for example, at the demand of a vehicle operator or automatically through a sensing system, the heated fluid 38 may not cause thermal shock or freeze on the windscreen (not shown). Additionally, in an embodiment, the reservoir 40 contains sufficient reserve fluid 38 such that dirt, debris and foreign fluid may be washed away with the assistance of windshield wipers before being exhausted or running cold.

In an embodiment, the wiper fluid heating and control system may be installed integrally with newly manufactured vehicles and incorporated in the electronic control module or installed on board the ECM at an extra port.

In an embodiment, ⅝″ rubber tubing may be used for the lines. Also in an embodiment, the system may be installed, after market, in vehicles as a retro-fit kit or at the time of manufacture of the vehicle or installed after market as a retro-fit kit.

The exemplary embodiments described herein are not intended to be exhaustive or to limit the scope of the invention to the precise forms disclosed. They are chosen and described to explain the principles of the invention and its application and practical use to allow others skilled in the art to comprehend its teachings.

As will be apparent to those skilled in the art in light of this disclosure, many alterations and modifications are possible in the practice of this invention without departing from the spirit or scope thereof. Accordingly, the scope of the invention is to be construed in accordance with the substance defined by the following claims.

What is claimed is:

1. An apparatus for heating and controlling fluid temperature, the apparatus comprising:
a windshield washer fluid reservoir,
a heat tube disposed in the reservoir,
a valve for controlling a flow rate of a working fluid through the tube,
a control system for controlling a temperature of a fluid in the reservoir, the control system comprising
a first sensor disposed within the reservoir for measuring a first temperature within the reservoir,
a second sensor disposed outside of the reservoir for measuring a second temperature, and
a controller for adjusting the valve based on a differential between the first and second temperatures and the predetermined temperature differentials, and
a power source for delivering power to the control system.

2. The apparatus of claim 1 further comprising a microprocessor for storing predetermined temperature differentials between the first temperature and the second temperature, comparing the temperature differentials with the receiving measured first and second temperatures, and maintaining a temperature of the fluid in the reservoir.

3. The apparatus of claim 1, wherein the fluid in the reservoir comprises washer fluid.

4. The apparatus of claim 1, wherein the controller comprises an actuator.

5. The apparatus of claim 1, further comprising a pump for moving the working fluid through the tube.

6. The apparatus of claim 1, wherein the tube comprises a heat conductive material.

7. The apparatus of claim 1, wherein the working fluid comprises a heated working fluid.

8. The apparatus of claim 1, wherein the working fluid comprises a vehicle coolant fluid.

9. The apparatus of claim 1, wherein the working fluid comprises a vehicle coolant fluid.

10. The apparatus of claim 1, wherein the working fluid comprises a temperature that is greater than an ambient temperature.

11. A method for heating and controlling windshield washer fluid temperature in a vehicle, the method comprising:
providing apparatus for heating and controlling fluid temperature comprising providing
a windshield washer fluid reservoir,
a heat tube disposed in the reservoir,
a valve for controlling a flow rate of a working fluid through the tube,
a control system for controlling a temperature of a fluid in the reservoir, the control system comprising
a first sensor disposed within the reservoir for measuring a first temperature within the reservoir,
a second sensor disposed outside of the reservoir for measuring a second temperature, and
a controller for adjusting the valve based on a differential between the first and second temperatures and the predetermined temperature differentials, and
a power source for delivering power to the control system providing a stored predetermined temperature differential,
measuring a first temperature in the reservoir,
measuring a second temperature outside of the reservoir,
storing the first and second measured temperatures,
calculating an actual temperature differential between the measured temperatures,
comparing the actual temperature differential with the stored predetermined temperature differential, and
adjusting the delivery of heat to the fluid in the reservoir by adjusting the position of the valve in response to a differential between the actual temperature differential with the stored predetermined temperature differential.

12. The method of claim 13, the adjusting the delivery of heat to the fluid in the reservoir comprises
closing the valve if the actual temperature differential is equal to or less than the stored temperature differential, or
opening the valve if the actual temperature differential is greater than the stored temperature differential.

13. The method of claim 13, the providing comprising providing a microprocessor for storing predetermined temperature differentials between the first temperature and the second temperature, comparing the temperature differentials with the receiving measured first and second temperatures, and maintaining a temperature of the fluid in the reservoir.

14. The method of claim 13, the providing comprising providing the fluid in the reservoir comprises washer fluid.

15. The method of claim 13, the providing comprising providing the controller comprises an actuator.

16. The method of claim 13, the providing comprising providing a pump for moving the working fluid through the tube.

17. The method of claim 13, the providing comprising providing the tube comprises a heat conductive material.

18. The method of claim 13, the providing comprising providing the working fluid comprises a heated working fluid.

19. The method of claim 13, the providing comprising providing the working fluid comprises a vehicle coolant fluid.

20. The method of claim 13, the providing comprising providing the working fluid comprises a vehicle coolant fluid.

21. The method of claim 13, the providing comprising providing the working fluid comprises a temperature that is greater than an ambient temperature.
